(19) United States
(12) Patent Application Publication
(10) Pub. No.: US 2010/0054546 A1
(43) Pub. Date: Mar. 4, 2010

(54) Integrated resource management system

(75) Inventor: Cheol Ho Choi, Anyang-si (KR)

Correspondence Address: ABELMAN, FRAYNE & SCHWAB, 666 THIRD AVENUE, 10TH FLOOR, NEW YORK, NY, 10017, US

(73) Assignee: DOALLTECH SOLUTION PROVIDER

(21) Appl. No.: 12/150,276

(22) Filed: Apr. 24, 2008

(30) Foreign Application Priority Data
Mar. 18, 2008 (KR) 10-2008-0024915

(51) Int. Cl. G06K 9/00

(52) U.S. Cl. 382/115

(57) ABSTRACT

The present invention relates to an integrated resource management system, which can manage the authorization of the entry and exit of persons who enter and leave a construction site and the entry and exit of construction materials or construction equipment into and from a construction site in real time in an integrated manner, and can prevent the illegal incursion of outsiders, who are not authorized persons, and the forgery of the attendance and leave record information of entering and leaving persons through a multi-stage entry/exit authorization process.

### CROSS REFERENCE TO RELATED APPLICATION

This application claims the benefit of Korean Patent Application No. 10-2008-0024915, filed on Mar. 18, 2008, entitled “Resource Total Management System,” which is hereby incorporated by reference in its entirety into this application.

### BACKGROUND OF THE INVENTION

1. Field of the Invention

The present invention relates to an integrated resource management system, which can manage the authorization of the entry and exit of persons who enter and leave a construction site and the entry and exit of construction materials or construction equipment into and from a construction site in real time in an integrated manner, and can prevent the illegal incursion of outsiders, who are not authorized persons, and the forgery of the attendance and leave record information of entering and leaving persons through a multi-stage entry/exit authorization process.

2. Description of the Related Art

Generally, in a construction site, workers who work at the construction site enter and leave the construction site at various times, and construction materials or construction equipment necessary for building and construction enter and leave the construction site at all times.

Such a construction site is configured such that a device for controlling the entry and exit of workers is installed at a predetermined location at the construction site to check the attendance and leave record information of workers, and such that a separate manager manages the entry/exit of construction materials or construction equipment in an entry control office installed at a predetermined location at the construction site.

In this case, the attendance and leave record information of workers and the present state of the entry/exit of construction materials or construction equipment are not only separately managed at a relevant construction site, but are also checked only at the relevant construction site. Accordingly, it is impossible to check the attendance and leave record information of workers or the present state of the entry/exit of construction materials or construction equipment in real time from a head office.

Accordingly, there is a problem in that, in order to check the attendance and leave record information of workers or the present state of the entry/exit of construction materials or construction equipment in real time from a head office, unnecessary personnel expenses are incurred.

Further, since the attendance and leave record information of workers and the present state of the entry/exit of construction materials or construction equipment are individually managed, additional personnel expenses are required and a construction site is not efficiently managed in order to integrate the attendance and leave record information of workers with information about the present state of the entry/exit of construction materials or construction equipment.

### SUMMARY OF THE INVENTION

Accordingly, the present invention has been made keeping in mind the above problems occurring in the prior art, and the present invention is intended to provide an integrated resource management system, which can manage the authorization of the entry and exit of persons who enter and leave a construction site, and the entry and exit of construction materials or construction equipment into and from a construction site in real time in an integrated manner, thus efficiently managing the construction site.

Further, the present invention is intended to provide an integrated resource management system, which can prevent the illegal incursion of outsiders, who are not authorized persons, and the forgery of attendance and leave record information of entering and leaving persons through a multi-stage entry/exit authorization process.

In accordance with an aspect of the present invention, there is provided an integrated resource management system, comprising a data storage unit for storing personal information including a name, resident registration number, place, entry/exit information, and facial image information of a person authorized for entry and exit, finger bloodstream information of the person authorized for entry and exit, a registration number of a vehicle authorized for entry and exit and a unique number implemented using an encryption code; a card reader unit for reading the registration number of the vehicle authorized for entry and exit and information about entry/exit of construction materials or construction equipment while reading personal information, finger bloodstream information and a unique number of the entering and leaving person from an information identification card carried by the person; image capturing means for capturing a facial image of the entering and leaving person who carries the information identification card; a data comparison unit for comparing information read by the card reader unit with information stored in the data storage unit; a data output unit for notifying, using text or a voice, the entering and leaving person of availability of the information identification card, validity of entry and exit of the person, and validity of entry and exit of a vehicle depending on results of a comparison transmitted from the data comparison unit, and displaying the information about entry/exit of the construction materials or construction equipment read by the card reader unit; a data communication unit for receiving data and control signals from an external system in real time and transmitting the information, read by the card reader unit, and the results of the comparison, transmitted from the data comparison unit, to the external system in real time while performing data communication with the external system; and a control unit for opening or shutting an entrance so that the person enters and leaves the entrance depending on the results of comparison transmitted from the data comparison unit.

In an embodiment of the present invention, the data storage unit may store the personal information and the finger bloodstream information at an address number matching the unique number.

In an embodiment of the present invention, the integrated resource management system may further comprise a finger bloodstream detection unit for detecting the finger bloodstream information of the entering and leaving person.

In an embodiment of the present invention, the data comparison unit may respectively compare the personal information, read by the card reader unit, and the finger bloodstream information, detected by the finger bloodstream detection unit, with the personal information and the finger bloodstream information stored in the data storage unit.

In an embodiment of the present invention, the finger bloodstream detection unit may designate at least one point on a finger of the entering and leaving person using near-infrared light, capture a vein pattern from the designated point separate the captured vein pattern into two or more regions, set each of separation regions to 0 or 1 depending on whether the vein pattern exists in the separation region, and then convert the finger bloodstream information into digital data.

In an embodiment of the present invention, the integrated resource management system may further comprise a data input unit for receiving the unique number from the entering and leaving person.

In an embodiment of the present invention, the integrated resource management system may further comprise a temperature detection unit for detecting a temperature of the integrated resource management system.

In an embodiment of the present invention, the control unit may be operated such that, when there is a possibility of the temperature detected by the temperature detection unit increasing to a temperature higher than a suitable temperature, the control unit radiates heat generated from the integrated resource management system, and such that, when there is a possibility of the temperature detected by the temperature detection unit decreasing to a temperature lower than a suitable temperature, the control unit increases the temperature of the integrated resource management system.

In an embodiment of the present invention, the integrated resource management system may further comprise an infrared sensing unit for sensing movement of a vehicle at a site at which the integrated resource management system is installed.

In an embodiment of the present invention, the control unit may control the image capturing means so that, when the vehicle is sensed by the infrared sensing unit, the image capturing means captures an image of a license plate of the vehicle.

In an embodiment of the present invention, the integrated resource management system may further comprise an illuminance detection unit for detecting surrounding illuminance of the integrated resource management system.

In an embodiment of the present invention, the image capturing means may comprise a flash.

In an embodiment of the present invention, the image capturing means may capture a registration number of the vehicle or a facial image of the entering and leaving person after turning on the flash when the illuminance detected by the illuminance detection unit is equal to or less than a suitable value.

In an embodiment of the present invention, the control unit may control the image capturing means so that the image capturing means captures surroundings of the integrated resource management system in response to a capturing control signal transmitted from an external system through the data communication unit.

In an embodiment of the present invention, the integrated resource management system may further comprise a warning lamp unit for notifying the entering and leaving person of validity of entry and exit using a warning lamp.

In an embodiment of the present invention, the control unit may be operated such that, when external voltage, transmitted from an external power source, is higher than a drive voltage of the integrated resource management system, the control unit steps down the external voltage to the drive voltage of the integrated resource management system, and such that, when the external voltage is lower than the drive voltage of the integrated resource management system, the control unit steps up the external voltage to the drive voltage of the integrated resource management system, thus controlling power that is supplied to the integrated resource management system.

In an embodiment of the present invention, the control unit may be operated such that, when the external voltage, transmitted from the external power source, is interrupted, voltage from an internal power source is supplied to the integrated resource management system, and such that, when the external voltage is supplied again after interruption, the voltage from the internal power source is interrupted so that the external voltage from the external power source is supplied to the integrated resource management system.

In an embodiment of the present invention, the information identification card may be implemented using a Radio Frequency Identification (RFID) card.

In an embodiment of the present invention, when the integrated resource management system is installed in a construction site, the data storage unit may further store security management information, such as security rule violation information and security education state information of relevant workers in the construction site, material information, such as unique numbers of construction materials and parts used in the construction site, a factory approval date, an order date, a primary inspection date for products, a secondary inspection date for products, an entry date, a scheduled date of installation of construction materials and parts, an installation date, a present state of returned products, and quality, standards, and weights of materials, and information about administration of physical distribution, including information about a present state of exit from a factory, such as departure times of vehicles loaded with construction materials and parts, vehicle registration numbers, and amounts of materials loaded on vehicles, and information about a present state of entry into the construction site, such as entry/exit times of vehicles into/from the construction site, vehicle registration numbers, and amounts of materials.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing an integrated resource management system according to an embodiment of the present invention; and

FIG. 2 is a diagram showing a method of converting a vein pattern captured by the finger bloodstream detection unit of FIG. 1 into digital data.

### DESCRIPTION OF THE PREFERRED EMBODIMENTS

Hereinafter, embodiments of the present invention will be described in detail with reference to the attached drawings.

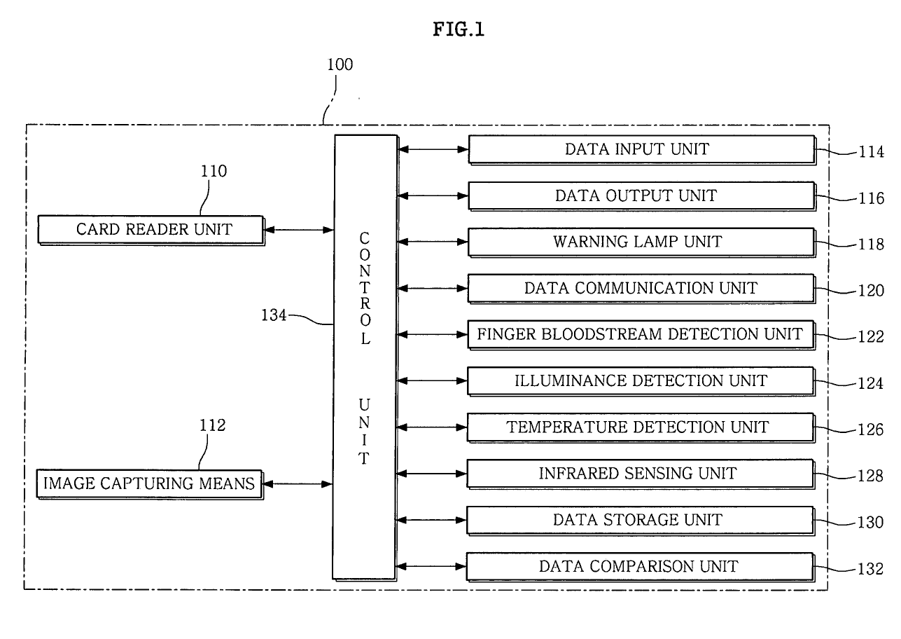

FIG. 1 is a diagram showing an integrated resource management system according to an embodiment of the present invention.

Referring to FIG. 1, an integrated resource management system 100 according to an embodiment of the present invention includes a card reader unit 110, an image capturing means 112, a data output unit 116, a data input unit 114, a warning lamp unit 118, a data communication unit 120, a finger bloodstream detection unit 122, an illuminance detection unit 124, a temperature detection unit 126, an in sensing unit 128, a data storage unit 130, a data comparison unit 132, and a control unit 134.

The integrated resource management system 100 further includes a power supply unit (not shown), the external casing of which is made of aluminum to allow the integrated resource management system 100 to be used at temperatures ranging from −20° C. to 70° C., and which is configured to supply voltage to the integrated resource management system 100.

In this case, the power supply unit (not shown) supplies external voltage, supplied by an external power source, to the integrated resource management system 100, or alternatively supplies voltage, supplied by an internal power source installed in the integrated resource management system 100 (for example, a solar cell, a battery, etc.) to the integrated resource management system 100.

That is, the power supply unit (not shown) supplies power, supplied by either one of the external power source and the internal power source, to the integrated resource management system 100.

The card reader unit 110 is a device for reading information stored in an information identification card (not shown) carried by an entering and leaving person, and is configured to read information stored in a relevant information identification card when the information identification card comes into contact with the card reader unit 110 or is spaced apart from the card reader unit 110 by a predetermined distance.

Here, the information identification card may be a Radio Frequency Identification (RFID) card or a barcode card.

Such a card reader unit 110 reads information about the entry/exit of construction materials or construction equipment, as well as the personal information of the entering and leaving person, including his or her attendance and leave record information, from the information identification card of the entering and leaving person.

In other words, when the integrated resource management system 100 is installed in a construction site, the card reader unit 110 reads the personal information of a relevant person who is working at the construction site, such as the name, resident registration number, place, entry/exit information, and facial image information thereof, the finger bloodstream information of the person, a unique number implemented using an encryption code, and the security rule violation information and security education state information of the person in the construction site, from the information identification card carried by the person, and also reads material information, such as the unique numbers of construction materials and parts used in the construction site, a factory approval date, an order date, a primary inspection date for products, a secondary inspection date for products, an entry date, the scheduled date of installation of construction materials and parts, an installation date, the present state of returned products, and the quality, standards, and weights of materials, information about the present state of exit from a factory, such as the departure time of vehicles loaded with construction materials and parts, vehicle registration numbers, and the amounts of materials loaded on vehicles, and information about the present state of entry into the construction site, such as the entry/exit times of vehicles into/from the construction site, vehicle registration numbers and the amounts of materials.

For this purpose, when the integrated resource management system 100 is installed in the construction site, the information identification card carried by a relevant person who is working at a construction site stores the personal information of the person, such as the name, resident registration number, place, entry/exit information, and facial image information thereof, the finger bloodstream information of the person, a unique number implemented using an encryption code, and security management information, such as the security rule violation information and security education state information of the person in the construction site, and also stores material information, such as the unique numbers of construction materials and parts used in the construction site, a factory approval date, an order date, a primary inspection date for products, a secondary inspection date for products, an entry date, the scheduled date of installation of construction materials and parts, an installation date, the present state of returned products, and the quality, standards, and weights of materials, information about the present state of exit from a factory, such as the departure time of vehicles loaded with construction materials and parts, vehicle registration numbers, and the amounts of materials loaded on vehicles, and information about the present state of entry into the construction site, such as the entry/exit times of vehicles into/from the construction site, vehicle registration numbers and the amounts of materials.

The image capturing means 112 is a device for capturing the physical image (for example, facial image) of an entering and leaving person to prevent the illegal use of the information identification card carried by the person, or illegal incursion, and is implemented using a high-resolution camera (12 fps, 640×480) installed at a predetermined location in the integrated resource management system 100.

The image capturing means 112 captures the physical image of the entering and leaving person when the person brings the information identification card into contact with the card reader unit 110 or places the information identification card at a position spaced apart from the card reader unit 110 by a predetermined distance, or when the entering and leaving person inputs data, that is, a unique number, into the data input unit 114.

Further, the image capturing means 112 captures the physical image of the entering and leaving person when the finger or palm of the person comes into close contact with the finger bloodstream detection unit 122, that is, when the finger bloodstream detection unit 122 detects the finger bloodstream information of the person.

Further, the image capturing means 112 captures the license plate of a vehicle when the vehicle is sensed by the infrared sensing unit 128, or captures the surroundings (for example, the inside of a construction site) of the site, at which the integrated resource management system 100 is installed, in response to a capturing control signal received from an external system through the data communication unit 120.

Accordingly, when the facial image included in the information read by the card reader unit 110 and the facial image captured by the image capturing means 112 are transmitted to a manager terminal (not shown) through the data communication unit 120, a manager who manages the integrated resource management system 100 compares the facial images displayed on the manager terminal (not shown) with each other, thus determining whether the relevant person is authorized for entry and exit.

Such an image capturing means 112 captures the physical image of an entering and leaving person or the registration number of a vehicle after selectively operating a flash according to illuminance information, received from the illuminance detection unit 124, at the time of capturing the physical image of an entering and leaving person or the license plate of a vehicle, that is, a registration number.

In other words, when the illuminance detected by the illuminance detection unit 124 is equal to or less than a suitable value, the image capturing means 112 captures the facial image of an entering and leaving person or the registration number of a vehicle after turning on the flash. Conversely, when the illuminance detected by the illuminance detection unit 124 is greater than a suitable value, the image capturing means 112 captures the facial image of the person or the registration number of the vehicle after turning off the flash.

For this purpose, the image capturing means 112 is configured to include the flash.

The data input unit 114, which receives the unique number from an entering and leaving person, is configured to transmit the unique number to the data comparison unit 132 when the person inputs a unique number.

The data output unit 116 notifies, using a voice, the entering and leaving person of the availability of the information identification card thereof, the validity of the entry and exit of the person, and the validity of the entry and exit of a vehicle while displaying the notification using text depending on the results of a comparison transmitted from the data comparison unit 132.

Further, the data output unit 116 displays the present state of the entry/exit of construction materials or construction equipment read by the card reader unit 110.

For this purpose, the data output unit 116 may include a display, such as a Liquid Crystal Display (LCD) or an electroluminescence (EL) display, and a speaker.

Further, the data output unit 116 notifies, using a voice, the entering and leaving person, or the manager who manages the integrated resource management system 100, of information transmitted from an external system through the data communication unit 120 (for example, the present state of transfer of construction materials or parts, the transfer of construction equipment, and official announcements) while displaying the information in text.

Here, the data input unit 114 and the data output unit 116 may be integrated into a single touch screen.

The warning lamp unit 118 notifies the entering and leaving person of the availability of the information identification card thereof; the validity of the entry and exit of the person, and the validity of the entry and exit of a vehicle using a warning lamp depending on the results of a comparison transmitted from the data comparison unit 132.

Such a warning lamp unit 118 is implemented using a Light Emitting Diode (LED) and is configured to turn on a blue warning lamp with respect to an entering and leaving person when an information identification card is available or when the person or a vehicle is authorized for entry and exit, and to turn on a red warning lamp with respect to an entering and leaving person when an information identification card is not available or when the person or the vehicle is not authorized for entry and exit.

The data communication unit 120 performs wired data communication or wireless data communication with a communication network to which the integrated resource management system 100 is connected.

Accordingly, through the data communication unit 120, the integrated resource management system 100 not only receives data from an external system, but also transmits the results of a comparison, obtained by the data comparison unit 132, or the image, captured by the image capturing means 112, to an external system.

Due thereto, the manager server (not shown), which manages the integrated resource management system 100, can manage the integrated resource management system 100 in real time on the basis of the data transmitted from the integrated resource management system 100.

For example, when the integrated resource management system 100 is installed in a construction site, the management server (not shown) can monitor and manage the attendance and leave record information of workers working in the construction site, information about the illegal incursion of outsiders, information about the attendance/leave violation of workers, the entry/exit authorization information of workers, or information about the present state of the entry/exit of construction materials or construction equipment in real time according to the data transmitted from the integrated resource management system 100 through the data communication unit 120, thus efficiently managing the construction site.

The finger bloodstream detection unit 122 extracts the vein pattern of the finger or the palm of an entering and leaving person using near-infrared light, and converts the extracted vein pattern into digital data.

In this case, the finger bloodstream information, converted into the digital data, is transmitted to the data comparison unit 132.

Such a finger bloodstream detection unit 122 uses the fact that near-infrared light is absorbed by hemoglobin in the blood, and is configured to designate about three points on the finger or palm desired to be captured using near-infrared light and to capture vein images from the designated points.

Here, the number of points desired to be captured using near-infrared light can be varied according to the number of persons who enter and leave the site at which the integrated resource management system 100 is installed.

In other words, the number of points desired to be captured may be set to less than two, or more than four.

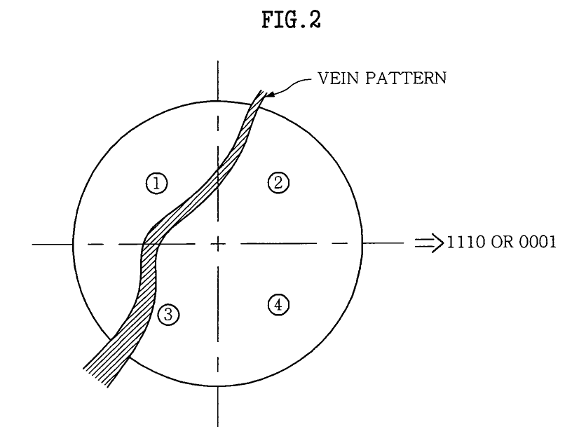

Further, the finger bloodstream detection unit 122 separates each portion captured by near-infrared light into four regions, as shown in FIG. 2, and sets each separation region to 0 or 1 depending on whether a vein pattern exists in the separation region.

That is, the finger bloodstream detection unit 122 sets a corresponding region to 0 when a vein pattern exists in each of the regions, separated into four for each point, and sets a corresponding region to 1 when a vein pattern does not exist in the region. Alternatively, the finger bloodstream detection unit 122 sets a corresponding region to 1 when a vein pattern exists, and sets a corresponding region to 0 when a vein pattern does not exist.

In this case, each captured portion may be divided into a different number of regions depending on the necessary degree of security.

In other words, the captured portion can be divided into more than four regions as the necessary degree of security increases, that is, if the requirement for security is high, and can be divided into less than four regions as the necessary degree of security decreases, that is, if the requirement for security is low.

As described above, the finger bloodstream detection unit 122 detects the finger bloodstream information of an entering and leaving person, converts the detected finger bloodstream information into digital data, and transmits the converted finger bloodstream information to the data comparison unit 132.

The illuminance detection unit 124 is installed at a predetermined location of the integrated resource management system 100 and is configured to sense the illuminance of the site at which the integrated resource management system 100 is installed.

When the surrounding illuminance of the integrated resource management system 100 is sensed as low illuminance by the illuminance detection unit 124, that is, when the area surrounding the integrated resource management system 100 is dark, the image capturing means 112 captures the physical image of the entering and leaving person or the registration number of a vehicle after turning on a flash. When the surrounding illuminance of the integrated resource management system 100 is sensed as high illuminance by the illuminance detection unit 124, that is, when the area surrounding the integrated resource management system 100 is bright, the image capturing means 112 captures the physical image of the person or the registration number of a vehicle after turning off the flash.

Accordingly, the manger who manages the integrated resource management system 100 can easily monitor the physical image or the registration number of the vehicle captured by the image capturing means 112.

The temperature detection unit 126 is installed at a predetermined location of the integrated resource management system 100 and is configured to detect the temperature of the integrated resource management system 100.

When there is a possibility of the temperature detected by the temperature detection unit 126 increasing to a temperature higher than a suitable temperature (65° C.), which is lower than the maximum operating temperature (70° C.) of the integrated resource management system 100, the control unit 134 radiates heat generated from the integrated resource management system 100 using a heat dissipation plate attached to the integrated resource management system 100. When there is a possibility of the temperature detected by the temperature detection unit 126 decreasing to a temperature lower than a suitable temperature (−15° C.), which is higher than the minimum operating temperature (−20° C.) of the integrated resource management system 100, the control unit 134 increases the temperature of the integrated resource management system 100 using a heat preservation plate attached to the integrated resource management system 100.

The infrared sensing unit 128 is installed at a predetermined location of the integrated resource management system 100 and is configured to detect the motion of vehicles, animals, and persons entering and leaving the site at which the integrated resource management system 100 is installed.

When a vehicle is detected by the infrared sensing unit 128, the image capturing means 112 captures the license plate of the vehicle, and the registration number, captured by the image capturing means 112, is transmitted to the data comparison unit 132.

The data storage unit 130 stores personal information, such as the name, resident registration number, place, entry/exit information, and facial image information of each person authorized to enter and leave the site at which the integrated resource management system 100 is installed, the finger bloodstream information of the authorized person, information about the registration number of each vehicle authorized to enter and leave the site, and information about the unique number of the entering and leaving person, implemented using encryption code (for example, an employee number or a password).

Here, the personal information, finger bloodstream information, and vehicle registration number information, stored in the data storage unit 130, are stored at an address number matching a corresponding unique number.

When the integrated resource management system 100 is installed in a construction site, the data storage unit 130 stores security management information, including security rule violation information and the present security education condition of relevant workers in the construction site, material information, such as the unique numbers, factory approval date, and order date of construction materials and parts used in the construction site, primary inspection date and secondary inspection date of products, warehousing date, the scheduled date of the installation of construction materials and parts, installation date, present returned conditions, quality, standards and weights, and information about the administration of physical distribution, including information about the present state of exit from a factory, such as departure time of vehicles loaded with construction materials and parts, vehicle registration numbers, and the amounts of materials loaded on vehicles, and information about the present state of entry into the construction site, such as the entry/exit times of vehicles into/from the construction site, vehicle registration numbers and the amounts of materials, in addition to the above information.

In this case, information stored in the data storage unit 130 may be transmitted to the management server, for controlling and managing the integrated resource management system 100, over a communication network, or may be updated to information transmitted from an external system through the data communication unit 120.

The data comparison unit 132 compares one or more items of the personal information transmitted from the card reader unit 110, the unique number transmitted from the data input unit 114, and the finger bloodstream information detected by the finger bloodstream detection unit 122, with the information stored in the data storage unit 130, and transmits the results of the comparison to the control unit 134.

That is, the data comparison unit 132 compares the personal information read by the card reader unit 110 with the personal information stored in the data storage unit 130, or respectively compares the unique number transmitted from the data input unit 114 and the finger bloodstream information detected by the finger bloodstream detection unit 122 with the unique number and the finger bloodstream information stored in the data storage unit 130.

Further, the data comparison unit 132 respectively compares the personal information read by the card reader unit 110 and the finger bloods information detected by the finger bloodstream detection unit 122 with the personal information and the finger bloodstream information stored in the data storage unit 130, or respectively compares the personal information read by the card reader unit 110, the unique number transmitted from the data input unit 114, and the finger bloodstream information detected by the finger bloodstream detection unit 122, with the personal information, the unique number, and the finger bloods information stored in the data storage unit 130.

The data comparison unit 132 compares the information of the entering and leaving person in the sequence of personal information->unique number->finger bloodstream information, or in the sequence of unique number->personal information->finger bloodstream information.

Further, the data comparison unit 132 compares the facial image transmitted from the image capturing means 112 with the facial image of the personal information stored in the data storage unit 130, or compares the vehicle registration number transmitted from the image capturing means 112 with the vehicle registration number stored in the data storage unit 130.

The control unit 134 controls the card reader unit 110, the image capturing means 112, the data output unit 116, the data input unit 114, the warning lamp unit 118, the data communication unit 120, the data storage unit 130, the data comparison unit 132, the finger bloodstream detection unit 122, the illuminance detection unit 124, the temperature detection unit 126, and the infra sensing unit 128.

The control unit 134 controls the data output unit 116 so that the data output unit 116 notifies, using text or a voice, the entering and leaving person of the availability of the information identification card thereof, the validity of the entry and exit of the person, and the validity of the entry and exit of a vehicle while opening or shutting an entrance so that the person can enter and leave the site at which the integrated resource management system 100 is installed, depending on the results of a comparison transmitted from the data comparison unit 132.

That is, if the results of the comparison transmitted from the data comparison unit 132 are consistent with each other the control unit 134 controls the data output unit 116 so that the data output unit 116 notifies the person of permission for entry and exit using text or a voice, whereas, if the results of comparison transmitted from the data comparison unit 132 are not consistent with each other, the control unit 134 controls the data output unit 116 so that the data output unit 116 notifies the person of refusal of entry and exit using text or a voice.

Further, the control unit 134 controls the data output unit 116 so that the data output unit 116 displays the present state of the entry/exit of construction materials or construction equipment read by the card reader unit 110.

Further, the control unit 134 controls the warming lamp unit 118 so that the warning lamp unit 118 displays the validity of the entry and exit of the person to the person depending on the results of comparison transmitted from the data comparison unit 132.

In other words, the control unit 134 controls the warning lamp unit 118 so that, when the results of the comparison transmitted from the data comparison unit 132 are consistent with each other, a blue warning lamp is turned on, and so that, when the results of the comparison are not consistent with each other, a red warning lamp is turned on.

Further, the control unit 134 controls the image capturing means 112 so that the image capturing means 112 captures the surroundings of the site (for example, the inside of a construction site), at which the integrated resource management system 100 is installed, in response to an externally applied capturing control signal.

Further, the control unit 134 controls the image capturing means 112 so that the flash installed in the image capturing means 112 is turned on or off according to the illumination value transmitted from the illuminance detection unit 124.

That is, the control unit 134 controls the image capturing means 112 so that, when the illuminance value transmitted from the illuminance detection unit 124 is equal to or less than a reference value (when the area surrounding the integrated resource management system is dark), the flash is turned on, and so that, when the illuminance value transmitted from the illuminance detection unit 124 is greater than the reference value (when the area surrounding the integrated resource management system is bright), the flash is turned off.

Further, the control unit 134 controls the image capturing means 112 so that, when a vehicle is sensed by the infrared sensing unit 128, the image capturing means 112 captures the license plate of the vehicle.

In this case, the control unit 134 controls the image capturing means 112 so that, when an animal or a person is sensed by the infrared sensing unit 128, the image capturing means 112 can capture the image of the animal or the person.

Such a control unit 134 further includes the function of controlling the voltage supplied to the integrated resource management system 100 in addition to the above-described control functions.

In other words, when external voltage, transmitted from an external power source, is higher than the drive voltage of the integrated resource management system 100, the control unit 134 steps down the external voltage to the drive voltage of the integrated resource management system 100, whereas, when the external voltage is lower than the drive voltage of the integrated resource management system 100, the control unit 134 steps up the external voltage to the drive voltage of the integrated resource management system 100.

Further, the control unit 134 performs control such that, when external voltage is interrupted, voltage from an internal power source (for example, a solar cell or a battery) is supplied to the integrated resource management system 100.

At this time, when external voltage is supplied again after interruption, the control unit 134 interrupts the supply of voltage from the internal power source to the integrated resource management system 100.

Such a control unit 134 further includes an 8-channel controller for controlling the operation of a swing gate, a turnstile, a switch, etc.

As described above, the integrated resource management system according to the embodiment of the present invention can manage the authorization of the entry and exit of persons who enter and leave a construction site, and the present state of the entry/exit of construction materials or construction equipment in an integrated manner in real time because the card reader unit 110 reads the personal information of the persons who enter and leave the construction site and the present state of the entry/exit of construction materials or construction equipment from the information stored in an information identification card, and the data communication unit 120 transmits the read information to an external system in real time, thus efficiently managing the construction site.

Further, since the present invention can perform the authorization of the entry and exit of entering and leaving persons in multiple stages by comparing the information input through the card reader unit 110, the image capturing means 112, the data input unit 114 and the finger bloodstream detection unit 122, with the information stored in the data storage unit 130, the security of authorization of the entry and exit of entering and leaving persons can be improved, and, in addition, the illegal incursion of outsiders, who are not authorized persons, and the forgery of the attendance and leave record information of entering and leaving persons can be prevented.

Further, since the present invention includes the card reader unit 110, the image capturing means 112, the data input unit 114 and the finger bloodstream detection unit 122, a person who enters and leaves a site at which the integrated resource management system 100 is installed can be authorized to enter and leave the site through the image capturing means 112, the data input unit 114, and the finger bloodstream detection unit 122 even if the person is not carrying his or her information identification card.

The integrated resource management system according to the embodiment of the present invention is configured to include all of the card reader unit 110, the image capturing means 112, the data input unit 114, and the finger bloodstream detection unit 122, but may be configured to include only the card reader unit 110, the image capturing means 112 and the finger bloodstream detection unit 122, omitting the data input unit 114, or to include only the card reader unit 110, the image capturing means 112 and the data input unit 114, omitting the finger bloodstream detection unit 122.

As described above, the present invention is advantageous in that, since a card reader unit reads the personal information of a person who enters and leaves a construction site and the present state of entry/exit of construction materials or construction equipment from information stored in an information identification card, and a data communication unit transmits the read information to an external system in real time, the authorization of the entry and exit of persons who enter and leave the construction site, and the present state of the entry/exit of construction materials or construction equipment can be managed in an integrated manner in real time, and thus the construction site can be efficiently managed.

Further, the present invention is advantageous in that since the authorization of the entry and exit of entering and leaving persons is performed in multiple stages by comparing the information input through a card reader unit, an image capturing means, a data input unit and a finger bloodstream detection unit, with the information stored in a data storage unit, the security of authorization of the entry and exit of entering and leaving persons can be improved, and, in addition, the illegal incursion of outsiders, who are not authorized persons, and the forgery of the attendance and leave record information of entering and leaving persons can be prevented.

Furthermore, the present invention is advantageous in that, since an integrated resource management system includes a card reader unit, an image capturing means, a data input unit and a finger bloodstream detection unit, a person who enters and leaves a site at which the integrated resource management system is installed can be authorized to enter and leave the site through the image capturing means, the data input unit, and the finger bloodstream detection unit even if the person is not carrying his or her information identification card.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An integrated resource management system, comprising:
a data storage unit for storing personal information including a name, resident registration number, place, entry/exit information, and facial image information of a person authorized for entry and exit, finger bloodstream information of the person authorized for entry and exit, a registration number of a vehicle authorized for entry and exit, and a unique number implemented using an encryption code;
a card reader unit for reading the registration number of the vehicle authorized for entry and exit and information about entry/exit of construction materials or construction equipment while reading personal information, finger bloodstream information and a unique number of the entering and leaving person from an information identification card carried by the person;
image capturing means for capturing a facial image of the entering and leaving person who carries the information identification card,
a data comparison unit for comparing information read by the card reader unit with information stored in the data storage unit;
a data output unit for notifying, using text or a voice, the entering and leaving person of availability of the information identification card, validity of entry and exit of the person, and validity of entry and exit of a vehicle depending on results of a comparison transmitted from the data comparison unit, and displaying the information about entry/exit of the construction materials or construction equipment read by the card reader unit;
a data communication unit for receiving data and control signals from an external system in real time and transmitting the information, read by the card reader unit, and the results of the comparison, transmitted from the data comparison unit, to the external system in real time while performing data communication with the external system; and
a control unit for opening or shutting an entrance so that the person enters and leaves the entrance depending on the results of comparison transmitted from the data comparison unit.

2. The integrated resource management system according to claim 1, wherein the data storage unit stores the personal information and the finger bloodstream information at an address number matching the unique number.

3. The integrated resource management system according to claim 1, further comprising a finger bloodstream detection unit for detecting the finger bloodstream information of the entering and leaving person.

4. The integrated resource management system according to claim 3, wherein the data comparison unit respectively compares the personal information, read by the card reader unit and the finger bloodstream information, detected by the finger bloodstream detection unit, with the personal information and the finger bloodstream information stored in the data storage unit.

5. The integrated resource management system according to claim 3, wherein the finger bloodstream detection unit designates at least one point on a finger of the entering and leaving person using near-infrared light, captures a vein pattern from the designated point, separates the captured vein pattern into two or more regions, sets each of separation regions to 0 or 1 depending on whether the vein pattern exists in the separation region, and then converts the finger bloodstream information into digital data.

6. The integrated resource management system according to claim 1, further comprising a data input unit for receiving the unique number from the entering and leaving person.

7. The integrated resource management system according to claim 1, further comprising a temperature detection unit for detecting a temperature of the integrated resource management system.

8. The integrated resource management system according to claim 7, wherein the control unit is operated such that, when there is a possibility of the temperature detected by the temperature detection unit increasing to a temperature higher than a suitable temperature, the control unit radiates heat generated from the integrated resource management system, and such that, when there is a possibility of the temperature detected by the temperature detection unit decreasing to a temperature lower than a suitable temperature, the control unit increases the temperature of the integrated resource management system.

9. The integrated resource management system according to claim 1, further comprising an infrared sensing unit for sensing movement of a vehicle at a site at which the integrated resource management system is installed.

10. The integrated resource management system according to claim 9, wherein the control unit controls the image capturing means so that, when the vehicle is sensed by the infrared sensing unit, the image capturing means captures an image of a license plate of the vehicle.

11. The integrated resource management system according to claim 1, further comprising an illuminance detection unit for detecting surrounding illuminance of the integrated resource management system.

12. The integrated resource management system according to claim 11, wherein the image capturing means comprises a flash.

13. The integrated resource management system according to claim 12, wherein the image capturing means captures a registration number of the vehicle or a facial image of the entering and leaving person after turning on the flash when the illuminance detected by the illuminance detection unit is equal to or less than a suitable value.

14. The integrated resource management system according to claim 1, wherein the control unit controls the image capturing means so that the image capturing means captures surroundings of the integrated resource management system in response to a capturing control signal transmitted from an external system through the data communication unit.

15. The integrated resource management system according to claim 1, further comprising a warning lamp unit for notifying the entering and leaving person of validity of entry and exit using a warning lamp.

16. The integrated resource management system according to claim 1, wherein the control unit is operated such that, when external voltage, transmitted from an external power source, is higher than a drive voltage of the integrated resource management system, the control unit steps down the external voltage to the drive voltage of the integrated resource management system, and such that, when the external voltage is lower than the drive voltage of the integrated resource management system, the control unit steps up the external voltage to the drive voltage of the integrated resource management system, thus controlling power that is supplied to the integrated resource management system.

17. The integrated resource management system according to claim 16, wherein the control unit is operated such that, when the external voltage, transmitted from the external power source, is interrupted, voltage from an internal power source is supplied to the integrated resource management system, and such that when the external voltage is supplied again after interruption, the voltage from the internal power source is interrupted so that the external voltage from the external power source is supplied to the integrated resource management system.

18. The integrated resource management system according to claim 1, wherein the information identification card is implemented using a Radio Frequency Identification (RFID) card.

19. The integrated resource management system according to claim 1, wherein, when the integrated resource management system is installed in a construction site, the data storage unit further stores security management information, such as security rule violation information and security education state information of relevant workers in the construction site, material information, such as unique numbers of construction materials and parts used in the construction site, a factory approval date, an order date, a primary inspection date for products, a secondary inspection date for products, an entry date, a scheduled date of installation of construction materials and parts, an installation date, a present state of returned products, and quality, standards, and weights of materials, and information about administration of physical distribution, including information about a present state of exit from a factory, such as depart times of vehicles loaded with construction materials and parts, vehicle registration numbers, and amounts of materials loaded on vehicles, and information about a present state of entry into the construction site, such as entry/exit times of vehicles into/from the construction site, vehicle registration numbers, and amounts of materials.
